(19) United States
(12) Patent Application Publication
(10) Pub. No.: US 2017/0025191 A1
(43) Pub. Date: Jan. 26, 2017

(54) Material arrangement for fusion reactor and method for producing the same

(71) Applicant: Airbus DS GmbH, Taufkirchen (DE)

(72) Inventor: Bernhard Kotzias, Bremen (DE)

(21) Appl. No.: 15/070,172

(22) Filed: Mar. 15, 2016

(30) Foreign Application Priority Data
Mar. 16, 2015 (DE) 102015103843.9
Sep. 3, 2015 (DE) 102015114749.1

(51) Int. Cl. G21B 1/19

(52) U.S. Cl. CPC G21B 1/19; G21Y 2004/101

(57) ABSTRACT

A material arrangement for a fusion reactor comprising at least one material which is configured as a foam-like carrier material for condensable binding and fusing of hydrogen. The carrier material is provided with positively charged vacancies for condensing hydrogen atoms, small pores for receiving the condensate and for accelerating the condensation after previous penetration of atoms or molecules into these, and large pores for transporting a catalyst into the small pores. Furthermore, a method for producing the material arrangement is disclosed.

### CROSS-REFERENCES TO RELATED APPLICATIONS

This application claims the benefit of the German patent application No. 102015114749.1 filed on Sep. 3,2015 and of the German patent application No. 102015103843.9 filed on Mar. 16,2015, the entire disclosures of which are incorporated herein by way of reference.

### BACKGROUND OF THE INVENTION

The invention relates to a material arrangement for a fusion reactor which is configured as a foam-like carrier material for condensable binding and fusing of hydrogen as well as to a method for producing the material arrangement.

In many areas alternative energy sources are being sought which should, in particular, obviate the problems of energy sources based on nuclear reactions or fossil fuels. Here mention is usually made of fusion processes which should have the potential to be durable, environmentally friendly and reliable.

In addition to hot fusion, various fusion processes in the field of cold fusion have already been described. In this case these frequently lack demonstrable functionality and efficiency. A development in the field of cold fusion towards the use of condensed matter is increasingly indicated.

For example, EP2680271A1 thus discloses a method and an apparatus for generating energy by nuclear fusion. In this case, gaseous hydrogen is catalytically condensed to ultra-dense hydrogen and collected on a carrier. The carrier is then brought into a radiation chamber in which the ultra-dense hydrogen can undergo fusion. Difficulties arise here, in particular, from the fact that the carrier must be transported under constant boundary conditions such as, for example, vacuum, so that the hydrogen cannot volatilize from its condensed state. The technical implementation of the method on an industrially usable apparatus can thus be very cumbersome.

In addition to EP2680271A1, mention can also be made of EP1551032A1. This describes a method for generating heat based on hydrogen condensates. In particular, hydrogen gas can be condensed on nanoparticles. For this purpose, the hydrogen gas must be exposed to high pressure. Due to ultrasound waves the condensed hydrogen atoms can fuse with one another and thus generate heat. Problematical here is the use of nanoparticles since, as a result of their reactivity, the effects on the environment have hitherto only been little clarified.

Further known from WO2009/125444A1 is a method and an apparatus for carrying out exothermic reactions between nickel and hydrogen. Hydrogen gas is brought under pressure into a tube filled with nickel powder. Under the action of heat, the system can be brought to fusion. In particular, the re-use or removal of nickel as a poisonous heavy metal appears problematical in this patent specification.

For technical applications under mechanically and thermally loaded environmental conditions, it has been found that metallic or ceramic foams specifically for the material of a fusion reactor are subjected to appreciable requirements with regard to the temperature resistance. If a stability above a temperature of 2000 oC is to be achieved, only materials such as, for example, zirconium oxide, silicon carbide, nitride ceramic, carbon structures or the like remain. These are either not sufficiently temperature-resistant under an oxygen atmosphere or are very brittle and therefore mechanically unstable. Zirconium oxide ceramic, for example, is also not very stable in its pure form and is particularly affected by decomposition during use. Furthermore, it is also not suitable to “survive” for long in a mechanically severely loaded environment with many vibrations. Even transport has considerable risks with regard to the mechanical stability of the material.

Furthermore, a controlled state must be present. No melting of the carrier material must occur. The catalyst must not experience any change in structure and undergo effects of heat from the fusion or it must revert to its old structure after the melting process. Thus, a temperature range for a practicable fusion process can be limited.

Furthermore, the process control of a fusion process constitutes a problem of reaction delays. If the process takes place too slowly or too weakly, this is unfavorable for the efficiency. A certain reactivity is therefore required so that the process starts sufficiently rapidly when energy is required.

In addition, radioactive reaction channels can occur or neutrons can appear. These should be minimized in order to implement a practical application of the system. Finally, the generated energy should end as heat and less as radiation. A model of the reaction channels is therefore essential.

### SUMMARY OF THE INVENTION

It is an object of the invention to provide a material arrangement for a fusion reactor which can condense hydrogen to the ultra-dense state and store it and which remains thermally and mechanically stable under reaction conditions or returns to a stable state. Furthermore, it is an object of the invention to provide a reliable method for producing such a material arrangement.

A material arrangement for a fusion reactor comprises at least one material which is configured as a foam-like carrier material for condensable binding and fusing of hydrogen. According to the invention, the carrier material is provided with positively charged vacancies for condensing hydrogen atoms and has small or smaller pores for receiving atoms or molecules and large or larger pores for transporting atoms or molecules, including one for transporting a second material, namely a catalyst, into the small pores. The material arrangement can in this case comprise a plurality of different carrier materials.

Positive charges exert an attractive force on the negative electrons of the hydrogen molecules as well as the lattice environment. If positive charge is introduced into a carrier material, the carrier material frequently has a function for the formation of ultra-dense hydrogen. The positive charges can, for example, be positive vacancies or local charge shifts due to polarization or influence in the carrier material.

In addition to small pores of the order of magnitude of 1-40 μm, the carrier material has large pores. The small pores and the surface thereof exert Casimir and capillary forces and have a positive effect on the condensation of hydrogen and can store the condensed hydrogen. The specific surface of the foam structure used for the formation of ultra-dense hydrogen is obtained substantially from these pores.

The large pores are between 40 μm and 100 μm in diameter and have only a small fraction in the formation of ultra-dense hydrogen. These pores are used to enable a coating with catalyst so that catalyst material in the form of a solution or plasma can be transported to the small pores. Consequently, the specific surface in a foam-like carrier material is further enlarged since the entire carrier material volume can be more reactive.

Preferably the pore size is selected so that it corresponds in the wavelength range to the maximum Planck radiation power in the temperature above 200 oC.

In this case, the material arrangement can comprise a common carrier material which is mechanically and thermally stable up to above 2000 oC and preferably is not toxic and also has no nanostructures so that manufacture is not made difficult by taking into account workplace safety guidelines for nanotechnology.

This can be implemented, for example, by open-pore microporous oxide materials. The carrier material can, for example, be produced by sintering. The starting material for this carrier, or also sinter structure need not necessarily be active per se and thus condense ultra-dense hydrogen. The property for forming ultra-dense hydrogen can be introduced, for example, by adding catalyst material. The catalyst can, for example, introduce positively charged vacancies into the sintered structure of the carrier material or be applied as a coating to the carrier material. Consequently, the carrier material can be activated and stabilized at the same time, where the capacity to store condensed hydrogen is simultaneously increased by produced further intermediate spaces or cavities.

The active carrier material here forms the ultra-dense hydrogen in two steps. Firstly, molecular hydrogen is split into atoms and then bound into the material lattice of the carrier material, with the result that the hydrogen atoms condense to ultra-dense hydrogen. The presence of positive vacancies and defined spin flow in this case results in the formation of collapsed states of hydrogen and hydrogen-like systems. An example for an oxide carrier material is zirconium dioxide which must be mechanically stabilized, in particular, in a microporous form. The stabilization of zirconium dioxide can, for example, be accomplished by introducing alkaline earth metals or yttrium or other atoms or molecules having one or two free valence electrons.

According to one exemplary embodiment of the material arrangement, the carrier material is meltable during a fusion, at least in certain areas and after a melting process and subsequent solidification has its initial structure. As a result of the high temperatures during a fusion, it cannot be excluded that the carrier material melts at least in certain areas. It is advantageous if the carrier material has an “alpha” lattice structure (cubic or differently space-centered). The carrier material should be selected in this case so that even while delivering the highest possible energy during a fusion, the material does not change its alpha lattice state or if this is changed, for example due to melting, the alpha lattice state is achieved again after the solidification.

In a further exemplary embodiment of the material arrangement, the carrier material is provided with positively charged vacancies by doping which specifically contain spin currents from the doping material. By this means, the carrier material can be flexibly doped by a plurality of methods and with different materials with positively charged vacancies.

According to a preferred exemplary embodiment of the material arrangement, a further material is provided which is applied as a catalyst coating for the mechanical and/or chemical stabilization and/or acceleration. The catalyst coating can be applied in this case by means of a transport liquid. The large pores can be used here to bring the catalyst in the transport liquid onto the surface of the small pores which adjoin the large pores. The coating of the catalyst must be accomplished here so that the large and the small pores are not closed as a result. As a result of the catalyst coating, the material arrangement is more spontaneous and more active in the process of condensation of hydrogen to ultra-dense hydrogen. The storage of the condensed ultra-dense hydrogen is substantially taken over by the small pores.

For example, titanium oxide can be used alone or with additional materials as catalyst. This material can also form superconducting hydrogen at high temperatures and thus makes the material arrangement more reactive for a fusion. Alternatively, nickel with up to 20 mass % copper can be used as catalyst. This material can also form a large amount of ultra-dense hydrogen capable of fusion. Alternatively, both catalysts can be mixed in order to reduce the transition of the transition temperature at which the material arrangement is no longer reactive.

Depending on the material, the catalyst can be active between 600 and 725 K at a negative pressure of less than 0.1 bar. Alternatively, a plurality of catalyst coatings can be applied. In the preferred example, two layers are applied.

According to one exemplary embodiment of the material arrangement, the catalyst coating has positively charged vacancies. The catalyst can, for example, be titanium oxide, with embedded elements such as antimony, nickel, aluminum or other transition metals or metalloids which form a positively charged vacancy in the grain region of the element. With this method the material arrangement is mechanically more stable and it is active in the formation of ultra-dense hydrogen.

In a further exemplary embodiment of the material arrangement, the carrier material is mixed with positively charged vacancies by doping and by a catalyst coating. The capability of the material arrangement to condense hydrogen to ultra-dense hydrogen is improved by this measure.

According to a further exemplary embodiment of the material arrangement, the catalyst coating is meltable during a fusion, at least in certain areas and after a melting process has its initial structure Similarly to the carrier material, the catalyst coating can also melt in certain areas during a fusion. Here it is advantageous if the catalyst coating in the molten state cannot cause any damage to the carrier material and does not close the pores. Furthermore, it is advantageous if the catalyst coating re-crystallizes into its original structure during solidification and thus is available for further fusion processes.

In a further exemplary embodiment of the material arrangement, the foam-like carrier material and/or the catalyst coating is/are fusion temperature resistant. If the materials are selected so that these do not melt during a fusion, damage to the material arrangement during a fusion can be minimized. Alternatively, the reaction heat can be removed so rapidly during a fusion that the melting points of the materials used in the material arrangement are not reached.

According to a further exemplary embodiment, the carrier material is a metal oxide, a ceramic or a carbon structure. This gives a plurality of possibilities for implementing a material arrangement.

In a preferred exemplary embodiment of the material arrangement, a superconducting liquid can be formed on the carrier material so that a probability of an electromagnetic resonance is increased. The ratio Q/V, i.e., the Q factor of the resonance of an electromagnetic wave to the volume in which the wave exciting this takes place is an important parameter in the quantum electrodynamics of cavities. The higher the Q factor, the lower the damping and the more defined the resonances or in other words, the lower the energy loss from the cavity or the hollow body. The smaller the volume, the higher the energy density per volume and therefore the higher the generated energy.

If the ratio Q/V is selected to be sufficiently high, positive reversible thermodynamic effects are obtained. With increasing Q factor, the cavities reflect the electromagnetic waves increasingly effectively and therefore reduce possible losses.

In a method for producing a material arrangement for a fusion reactor according to the invention, a carrier material raw material is provided which is converted into a foam-like carrier material. According to the invention, positively charged vacancies are introduced into and/or onto the foam-like carrier material. A foam-like carrier material has a large specific surface area which is relevant for the generation and fusion of ultra-dense hydrogen. By introducing further materials into the carrier material, positively charged vacancies can be formed therein, for example, by doping. This has an effect on the material properties of the carrier material. Advantageously the composition is selected so that the melting point and the mechanical and chemical stability of the carrier material are increased.

In a preferred exemplary embodiment of the method for producing a material arrangement, the foam-like carrier material is mixed with the catalyst and brought to sintering. The chemical and mechanical stability of the carrier material is thereby increased. By subsequent catalyst coating in particular the reactivity with regard to the formation of ultra-dense hydrogen and fusion is increased.

In a further exemplary embodiment of the method for producing a material arrangement, doping is applied to introduce positively charged vacancies into the carrier material and/or into the catalyst coating. The method of doping is already known from the field of semiconductor technology and offers a high flexibility in the production of the material arrangement.

According to a further exemplary embodiment of the method for producing a material arrangement, transition metals or metalloids are used for the doping of the carrier material. These form positively charged vacancies in the atomic range of the carrier material and improve the capability of the material arrangement to condense hydrogen atoms and molecules to ultra-dense hydrogen.

According to a further exemplary embodiment of the method for producing a material arrangement, the catalyst coating is used for introducing positively charged vacancies onto the carrier material. In this case, the doping of the carrier material can be omitted, whereby the method can be simplified.

### BRIEF DESCRIPTION OF THE DRAWINGS

In the following a preferred exemplary embodiment of the invention is explained in detail with reference to highly simplified schematic diagrams. In the figures:

FIG. 1 shows a section through an exemplary embodiment of the apparatus according to the invention,

FIG. 2 shows an enlarged view of section A from FIG. 1

FIG. 3 shows an enlarged view of section B from FIG. 2,

FIG. 4 shows a schematic view of a charging process according to the method according to the invention,

FIG. 5 shows a schematic view of a fusion process according to the method according to the invention,

FIG. 6 shows a section through an exemplary embodiment of the material arrangement according to the invention,

FIG. 7 shows a schematic view of a method according to the invention for producing a material arrangement.

In the drawings the same constructive elements each have the same reference numbers.

### DETAILED DESCRIPTION OF THE PREFERRED EMBODIMENTS

FIG. 1 shows a section through an exemplary embodiment of the apparatus 1 according to the invention for carrying out the method according to the invention for producing and for fusing ultra-dense hydrogen.

The apparatus 1 according to the exemplary embodiment comprises a cavity 2 which is open in places for receiving a gas. The gas here is preferably a hydrogen gas in its molecular form exposed to negative pressure, which is immediately converted into an atomic plasma in the cavity 2.

The cavity 2 is a pore of an open-pore metal foam or ceramic foam 4. The material of the metal foam or ceramic foam 4 should be selected in this case so that even while delivering the highest possible energy during a fusion, the material does not change its alpha lattice state or if this is changed, the alpha lattice state is achieved again.

According to the exemplary embodiment, the pore of the metal foam 4 is at least partially provided with a catalyst coating 6 in the inner side. The catalyst coating 6 here has a granular structure and according to the exemplary embodiment, contains titanium oxide. The catalyst coating can also be constructed of Fe2O3, Ni, MnO and other materials which can be applied to the metal foam or the ceramic foam as a thin perturbed regular lattice structure having a layer thickness of 10 nm to 4 μm.

Furthermore, the apparatus 1 has an initiating source 8 which can trigger a fusion process in a cavity 2. According to the exemplary embodiment shown, the initiating source 8 is a source of coherent, monochromatic light 8 which can act upon the cavity 2 with electromagnetic radiation. The initiation is accomplished by the thermal radiation of the cavity walls where due to resonance effects with the walls now mirror-coated by the superfluid hydrogen, preferred wavelengths or frequencies occur with high field intensity. The repulsive potential between protons is very high. The protons are the nuclei of the hydrogen. They undergo their repulsion due to their positive charge (Coulomb repulsion). In ultra-dense hydrogen the nuclei are very tightly packed and therefore very close. The repulsive potential of the nuclei is reduced here by the spherical expansion of the charge and matter cloud of the proton. Furthermore, this repulsion is very severely reduced by other forces such as strong interaction, weak interaction and gravitation and by the shielding of electron states. If ultra-dense hydrogen 12 is formed, the density is very high and the fusion partners, here hydrogen atoms 12, are therefore close to the fusion barrier. Accordingly, a small energy contribution is already sufficient to initiate a fusion. According to the exemplary embodiment, such an ignition of the fusion process is either executed by a coherent monochromatic light source 8 or by the natural black body radiation of the cavity 2, but can also be accomplished by external ionization, for example, by high voltage. Alternatively, a simple spark plug can also be used as initiating source 8 for this purpose.

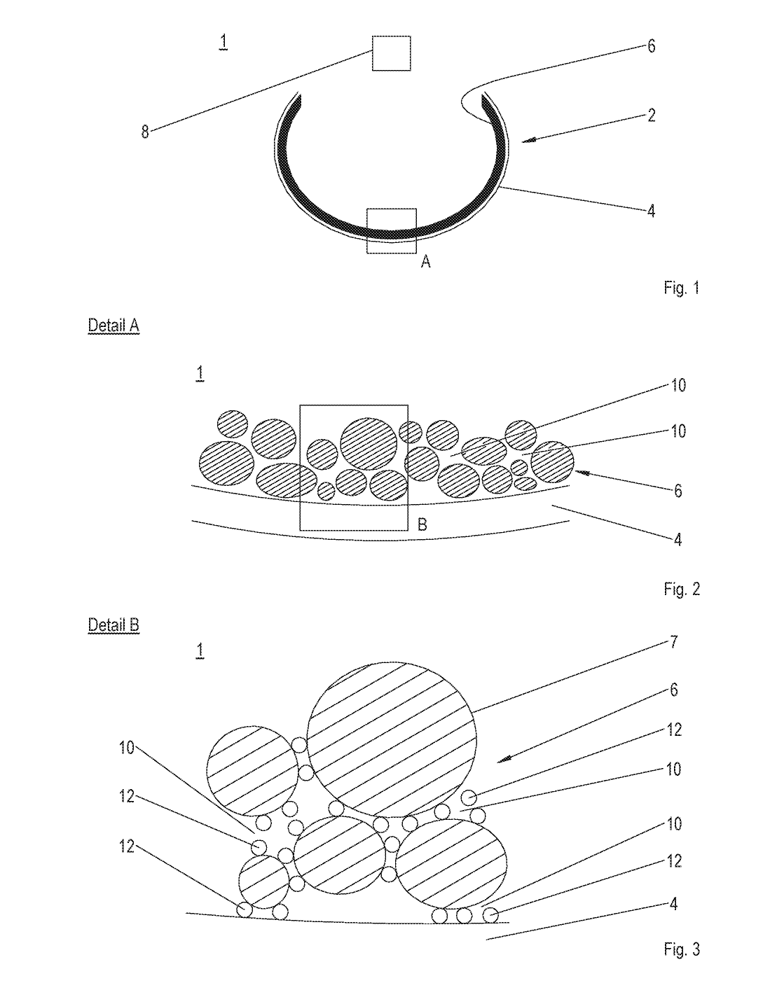

FIG. 2 shows an enlarged view of the section A from FIG. 1. In particular, the granular structure of the catalyst coating 6 is illustrated here. As a result, a Casimir geometry is created with a plurality of cavities 10 which exert capillary and/or Casimir forces on matter. Thus, corresponding forces can also act on a molecular hydrogen introduced into the cavity 2. Furthermore, the “Purcell Effect” is known for such structures, which amplifies electromagnetic processes many times.

FIG. 3 shows a further enlargement of the structure from the exemplary embodiment of the apparatus 1 according to the invention of section B from FIG. 2. Here it is illustrated that the granular structure of the catalyst coating 6 splits molecular hydrogen into atomic hydrogen and this then condenses into ultra-dense hydrogen 12 in the cavities 10 or the Casimir geometries 10. This corresponds to a charged state of the apparatus 1.

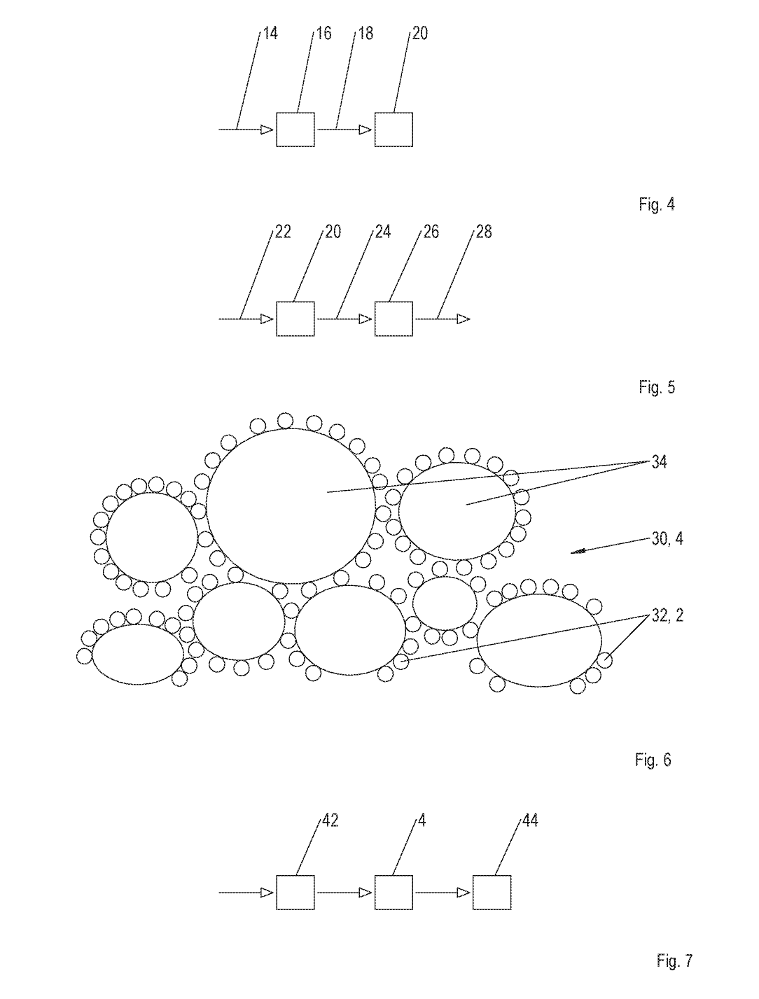

The method according to the invention for generating and fusing ultra-dense hydrogen is explained hereinafter. FIG. 4 shows a schematic view of a charging process of the apparatus 1 according to the method according to the invention. In this case, a gas (reference number 14) is introduced into the cavity 2, which is to be catalyzed and condensed. According to the exemplary embodiment, the gas is molecular hydrogen. Through contact of the hydrogen gas with the catalyst coating 6, the energy required for a plasma formation, and also for a condensate formation, is reduced to such an extent (reference number 16) that this can take place spontaneously at room temperature and even lower temperatures. According to the exemplary embodiment, the condensate is atomic hydrogen which has been catalytically split. The atomic hydrogen then condenses (reference number 20) in the Casimir geometry and becomes embedded in the catalyst coating 6 and is thus present in condensed form as ultra-dense hydrogen 12.

FIG. 5 shows a possible fusion process according to the method according to the invention. An apparatus 1 charged, for example according to FIG. 4, is assumed. An embedded (reference number 20) condensed ultra-dense hydrogen 12 is excited energetically by an initiating source 8. The condensed hydrogen forms clusters 12. These lie tightly squeezed together and between the heavy catalyst particles 7. The hydrogen protons are very tightly packed—the packing density being obtained from the quantum-mechanical state of the binding electrons in cooperation with the protons. The near field of the catalyst particles 7 assists the condensation. The packing density of the protons lies within the critical density for penetration of the fusion barrier. The energy contribution 22 from the initiating source 8 thus induces a fusion process 24 of the ultra-dense hydrogen. In particular helium, which can volatilize from the catalyst coating 6, is formed by the fusion process 24. In addition to helium, reaction energy 26 in the form of heat is produced. This reaction energy 26 is then guided out from the apparatus 1 via the metal foam/ceramic foam 4 by means of heat conduction and at the surface thereof by means of thermal radiation (reference number 28) or is guided into adjacent regions of the apparatus. The reaction energy 26 can thus be used, for example, for the ignition of fusion in neighboring apparatuses. Furthermore, the reaction energy, in particular reaction heat, can also be converted conventionally into mechanical, chemical or electrical energy and utilized.

FIG. 6 shows a section through an exemplary embodiment of the material arrangement 30 according to the invention which comprises a metal foam 4 with a catalyst coating 6 (not visible in FIG. 6). The cavity 2 shown in FIG. 1 here corresponds to a small pore 32 of the material arrangement 30.

The material arrangement 30 furthermore has large pores 34 which bind the small pores 32, for example, for the transport of hydrogen molecules. The large pores 34 are also used for the application and transport of the catalyst coating 6 so that the small pores 32 are also coated.

FIG. 7 shows a schematic view of a method 40 according to the invention for producing a material arrangement 30. In this case, in the first step a carrier material raw material 42 is prepared. The carrier material raw material 42 is here a powder and is then converted, for example by sintering at 1500 degrees C., into a foam-like carrier material 4 and optionally previously as well as additionally subsequently made reactive for the condensation and storage of hydrogen by introducing positively charged vacancies 44. The introduction of positively charged vacancies is accomplished, according to the exemplary embodiment, by introducing external crystals into the starting material to produce the carrier material or subsequently by coating with an oxide which forms positively charged vacancies by addition of external atoms.

Positively charged vacancies are mentioned here as a synonym for electronic systems which have a spin current (e.g., two free aligned electronic spin states having an integer spin which characterizes a Bosean state.

As a possible example for the production of the material arrangement 30, ZrO2 is mixed with 13 mol. % yttrium and a catalyst solution of 10 weight % of catalyst in heptane. At the same time, 60-70 volume % of 150 μm large carbon particles is added. This mixture is heated to 200 oC while stirring until the heptane has volatilized. A mass remains which, when cooled, can be pressed into a mold at a pressure of at least 5 kN. In this case, the pore size of the material arrangement 30 is dependent on the pressure applied here. The higher the pressure, the smaller are the pores 32, 34. However, low pressure here can adversely affect the mechanical stability. The pressed mold is then exposed to heat and sintered while adding oxygen. As a result, the carbon particles react with oxygen to carbon dioxide and volatilize from the mold so that a microporous structure remains.

Then, after cooling, a further catalyst coating 6 can be applied. This is accomplished, for example, by dissolving 25 g of a catalyst in 6 ml of methanol and subsequent impregnation of the structure with the solution. A drying process can be advantageous here at 200 oC for over 6 hours so that the methanol can volatilize.

Disclosed is a material arrangement 30 for a fusion reactor comprising at least one material which is configured as a foam-like carrier material 4 for condensable binding and fusing of hydrogen, where the carrier material 4 is provided with positively charged vacancies for condensing hydrogen atoms, small pores 32 for receiving atoms or molecules and large pores 34 for transporting atoms or molecules into the small pores 32. Furthermore, a method 40 for producing the material arrangement 30 is disclosed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-15. (canceled)

16. A material arrangement for a fusion reactor comprising:
at least one material which is configured as a foam-like carrier material for condensable binding and fusing of hydrogen, the carrier material having
positively charged vacancies for condensing hydrogen atoms,
small pores for receiving atoms or molecules, and
large pores for transporting atoms or molecules into the small pores.

17. The material arrangement according to claim 16, wherein the carrier material is meltable during a fusion, at least in certain areas, and, after a melting process, has its initial structure.

18. The material arrangement according to claim 16, wherein the carrier material is provided with positively charged vacancies by doping.

19. The material arrangement according to claim 16, wherein a further material is provided which is applied as a catalyst coating for at least one of mechanical stabilization, chemical stabilization or acceleration.

20. The material arrangement according to claim 19, wherein the catalyst coating has positively charged vacancies.

21. The material arrangement according to claim 16, wherein the carrier material is mixed with positively charged vacancies by doping and by a catalyst coating.

22. The material arrangement according to claim 19, wherein the catalyst coating is meltable during a fusion, at least in certain areas, and, after a melting process, has its initial structure.

23. The material arrangement according to claim 16, wherein at least one of the foam-like carrier material or the catalyst coating is fusion temperature resistant.

24. The material arrangement according to claim 16, wherein the carrier material is one of a metal oxide, a transition metal, a ceramic or a carbon structure.

25. The material arrangement according to claim 16, wherein a superconducting liquid can be formed on the carrier material and increases a probability of an electromagnetic resonance.

26. A method for producing a material arrangement for a fusion reactor comprising at least one material which is configured as a foam-like carrier material for condensable binding and fusing of hydrogen, the carrier material having positively charged vacancies for condensing hydrogen atoms, small pores for receiving atoms or molecules, and large pores for transporting atoms or molecules into the small pores, comprising the steps:
providing a carrier material raw material,
transferring the carrier material raw material into a foam-like carrier material, and
introducing positively charged vacancies at least one of into or onto the foam-like carrier material.

27. The method for producing a material arrangement according to claim 26, wherein the foam-like carrier material is stabilized with a catalyst coating.

28. The method for producing a material arrangement according to claim 27, wherein doping is applied to introduce positively charged vacancies into at least one of the carrier material or the catalyst coating.

29. The method for producing a material arrangement according to claim 26, wherein transition metals or metalloids are used for the doping of the carrier material.

30. The method for producing a material arrangement according to claim 26, wherein the catalyst coating is used for introducing positively charged vacancies onto the carrier material.
